(19) United States
(12) Patent Application Publication
(10) Pub. No.: US 2025/0119732 A1
(43) Pub. Date: Apr. 10, 2025

(54) ENCRYPTION KEY TRANSFER METHOD AND DEVICE FOR ROAMING USERS IN COMMUNICATION NETWORKS

(71) Applicant: ZTE Corporation, Shenzhen (CN)

(72) Inventors: Jigang WANG, Shenzhen (CN); Shilin YOU, Shenzhen (CN); Zhen XING, Shenzhen (CN); Yuze LIU, Shenzhen (CN); Peilin LIU, Shenzhen (CN)

(73) Assignee: ZTE Corporation, Shenzhen (CN)

(21) Appl. No.: 18/984,178

(22) Filed: Dec. 17, 2024

Related U.S. Application Data
(63) Continuation of application No. PCT/CN2022/129575, filed on Nov. 3, 2022.

(51) Int. Cl. H04W 12/0433; H04W 12/041; H04W 12/72; H04W 84/04

(52) U.S. Cl. CPC H04W 12/0433; H04W 12/041; H04W 12/72; H04W 84/042

(57) ABSTRACT

This disclosure generally relates to transferring encryption key to a VPLMN in wireless communication. Performed by first network element, the method includes: transmitting a query message to a second network element, to request an identification of a NF entity, wherein the query message comprises an identifier of a wireless device, and wherein the network function is an entity in the VPLMN for storing encryption keys; receiving, from the second network element, a response to the query message, the response comprising the identification of the NF entity; and transmitting, to the NF entity based on the identification of the NF entity, a first message comprising an encryption key, wherein the AF entity is located in the HPLMN or a DN external to the HPLMN and the VPLMN.

### TECHNICAL FIELD

This disclosure relates to wireless communication, and in particular, to transferring encryption key of a wireless device to a Visited Public Land Mobile Network (VPLMN).

### BACKGROUND

In a communication network, the mutual authentication of a User Equipment (UE) and the communication network may be performed to allow only authenticated UE and the authenticated communication network to communicate with each other. Application Function (AF) entities may provide various application services to the UE once authenticated. Efficient and robust authentication mechanism involving various network elements is critical to provide secure communication between Application Function entity and the UE, and to protect the credentials of the UE and the Application Function entity.

### SUMMARY

This disclosure discloses methods, systems, devices, and storage medium relates to wireless communication, and in particular, to transferring application key for application service of a wireless device to a VPLMN.

In one embodiment, the present disclosure describes a method for wireless communication. Performed by first network element in a HPLMN of a wireless device, the wireless device being served by a VPLMN, the method includes: transmitting a query message to a second network element, to request an identification of a Network Function (NF) entity, wherein the query message comprises an identifier of the wireless device, and wherein the network function is an entity in the VPLMN for storing encryption keys; receiving, from the second network element, a response to the query message, the response comprising the identification of the NF entity; and transmitting, to the NF entity based on the identification of the NF entity, a first message comprising: a target encryption key comprising one of: an AKMA application key (KAF) associated with the wireless device and an application function (AF) entity that the wireless device accesses for an application service, an encryption key derived from the application key, or an encryption key independent of the application key, wherein the AF entity is located in the HPLMN or a data network (DN) external to the HPLMN and the VPLMN.

In another embodiment, a network element or wireless device comprising a processor and a memory is disclosed. The processor may be configured to read computer code from the memory to implement any of the methods above.

In yet another embodiment, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows an exemplary communication network including various terminal devices, a carrier network, data network, and service applications.

FIG. 2 shows exemplary network functions or network nodes in a communication network.

FIG. 3 shows exemplary network functions or network nodes in a wireless communication network.

FIG. 4 shows an exemplary network model for an Authentication and Key Management for Applications (AKMA) framework.

FIG. 5 shows an example wireless network node (or network element, network entity, entity).

FIG. 6 shows an example user equipment.

FIG. 7 shows an exemplary key hierarchy under the AKMA framework.

FIGS. 8-11 show various exemplary logic flows for transferring application key to a network function in VPLMN.

FIG. 12 shows a high level system architecture for transferring application key to a network function in VPLMN.

### DETAILED DESCRIPTION

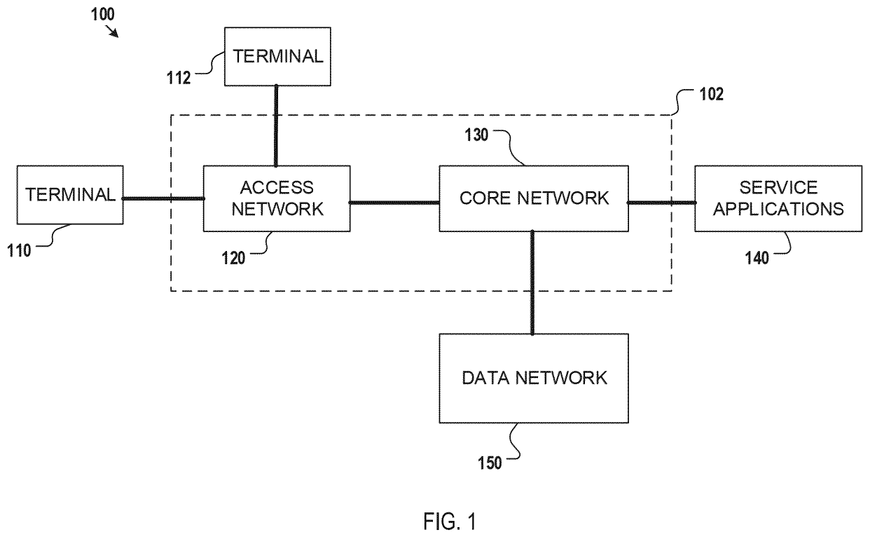

An exemplary communication network, shown as 100 in FIG. 1, may include terminal devices 110 and 112, a carrier network 102, various service applications 140, and other data networks 150. The carrier network 102, for example, may include access networks 120 and a core network 130. The carrier network 102 may be configured to transmit voice, data, and other information (collectively referred to as data traffic) among terminal devices 110 and 112, between the terminal devices 110 and 112 and the service applications 140, or between the terminal devices 110 and 112 and the other data networks 150. Communication sessions and corresponding data paths may be established and configured for such data transmission. The Access networks 120 may be configured to provide terminal devices 110 and 112 network access to the core network 130. The Access network 120 may, for example, support wireless access via radio resources, or wireline access. The core network 130 may include various network nodes or network functions configured to control the communication sessions and perform network access management and data traffic routing. The service applications 140 may be hosted by various application servers that are accessible by the terminal devices 110 and 112 through the core network 130 of the carrier network 102. A service application 140 may be deployed as a data network outside of the core network 130. Likewise, the other data networks 150 may be accessible by the terminal devices 110 and 112 through the core network 130 and may appear as either data destination or data source of a particular communication session instantiated in the carrier network 102.

The core network 130 of FIG. 1 may include various network nodes or functions geographically distributed and interconnected to provide network coverage of a service region of the carrier network 102. These network nodes or functions may be implemented as dedicated hardware network elements. Alternatively, these network nodes or functions may be virtualized and implemented as virtual machines or as software entities. A network node may each be configured with one or more types of network functions. These network nodes or network functions may collectively provide the provisioning and routing functionalities of the core network 130. The term “network nodes” and “network functions” are used interchangeably in this disclosure.

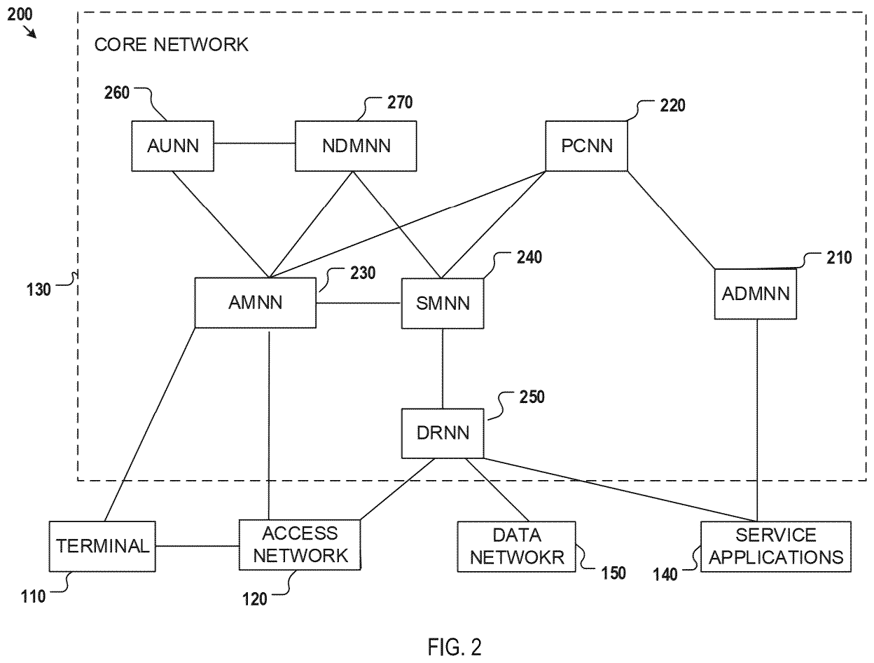

FIG. 2 further shows an exemplary division of network functions in the core network 130 of a communication network 200. While only single instances of network nodes or functions are illustrated in FIG. 2, those having ordinary skill in the art readily understand that each of these network nodes may be instantiated as multiple instances of network nodes that are distributed throughout the core network 130. As shown in FIG. 2, the core network 130 may include but is not limited to network nodes such as access management network node (AMNN) 230, authentication network node (AUNN) 260, network data management network node (NDMNN) 270, session management network node (SMNN) 240, data routing network node (DRNN) 250, policy control network node (PCNN) 220, and application data management network node (ADMNN) 210. Exemplary signaling and data exchange between the various types of network nodes through various communication interfaces are indicated by the various solid connection lines in FIG. 2. Such signaling and data exchange may be carried by signaling or data messages following predetermined formats or protocols.

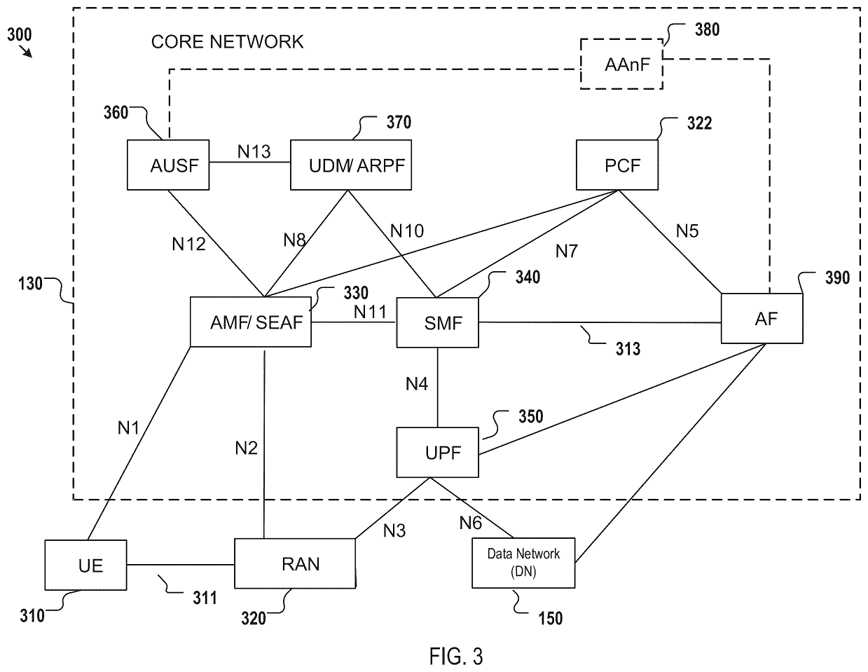

The implementations described above in FIGS. 1 and 2 may be applied to both wireless and wireline communication systems. FIG. 3 illustrates an exemplary cellular wireless communication network 300 based on the general implementation of the communication network 200 of FIG. 2. FIG. 3 shows that the wireless communication network 300 may include user equipment (UE) 310 (functioning as the terminal device 110 of FIG. 2), radio access network (RAN) 320 (functioning as the access network 120 of FIG. 2), data network (DN) 150, and core network 130 including access management function (AMF) 330 (functioning as the AMNN 230 of FIG. 2), session management function (SMF) 340 (functioning as the SMNN 240 of FIG. 2), application function (AF) 390 (functioning as the ADMNN 210 of FIG. 2), user plane function (UPF) 350 (functioning as the DRNN 250 of FIG. 2), policy control function 322 (functioning as the PCNN 220 of FIG. 2), authentication server function (AUSF) 360 (functioning as the AUNN 260 of FIG. 2), and universal data management (UDM) function 370 (functioning as the UDMNN 270 of FIG. 2). Again, while only single instances for some network functions or nodes of the wireless communication network 300 (the core network 130 in particular) are illustrated in FIG. 3, those of ordinary skill in the art readily understand that each of these network nodes or functions may have multiple instances that are distributed throughout the wireless communication network 300. While the AF 390 is depicted as part of the core network 130 in FIG. 3, they may be considered as associated with particular service applications 140 and may be considered as being outside of the core network 140. In this disclosure, various functions deployed in the wireless network as described above may also be referred to as function entities, which may be implemented as a network node, a network element, a logical function, via hardware, software, or a combination thereof.

In FIG. 3, the UE 310 may be implemented as various types of mobile devices that are configured to access the core network 130 via the RAN 320. The UE 310 may include but is not limited to mobile phones, laptop computers, tablets, Internet-Of-Things (IOT) devices, distributed sensor network nodes, wearable devices, and the like. The UE may also be Multi-access Edge Computing (MEC) capable UE that supports edge computing. The RAN 320 for example, may include a plurality of radio base stations distributed throughout the service areas of the carrier network. The communication between the UE 310 and the RAN 320 may be carried in over-the-air (OTA) radio interfaces as indicated by 311 in FIG. 3.

Continuing with FIG. 3, the UDM 370 may form a permanent storage or database for user contract and subscription data. The UDM may further include an authentication credential repository and processing function (ARPF, as indicated in 370 of FIG. 3) for storage of long-term security credentials for user authentication, and for using such long-term security credentials as input to perform computation of encryption keys as described in more detail below. To prevent unauthorized exposure of UDM/ARPF data, the UDM/ARPF 370 may be located in a secure network environment of a network operator or a third-party.

The AMF/SEAF 330 may communicate with the RAN 320, the SMF 340, the AUSF 360, the UDM/ARPF 370, and the Policy Control Function (PCF) 322 via communication interfaces indicated by the various solid lines connecting these network nodes or functions. The AMF/SEAF 330 may be responsible for UE to non-access stratum (NAS) signaling management, and for provisioning registration and access of the UE 310 to the core network 130 as well as allocation of SMF 340 to support communication need of a particular UE. The AMF/SEAF 330 may be further responsible for UE mobility management. The AMF may also include a security anchor function (SEAF, as indicated in 330 of FIG. 3) that, as described in more detail below, and interacts with AUSF 360 and UE 310 for user authentication and management of various levels of encryption/decryption keys. The AUSF 360 may terminate user registration/authentication/key generation requests from the AMF/SEAF 330 and interact with the UDM/ARPF 370 for completing such user registration/authentication/key generation.

The SMF 340 may be allocated by the AMF/SEAF 330 for a particular communication session instantiated in the wireless communication network 300. The SMF 340 may be responsible for allocating UPF 350 to support the communication session and data flows therein in a user data plane and for provisioning/regulating the allocated UPF 350 (e.g., for formulating packet detection and forwarding rules for the allocated UPF 350). Alternative to being allocated by the SMF 340, the UPF 350 may be allocated by the AMF/SEAF 330 for the particular communication session and data flows. The UPF 350 allocated and provisioned by the SMF 340 and AMF/SEAF 330 may be responsible for data routing and forwarding and for reporting network usage by the particular communication session. For example, the UPF 350 may be responsible for routing end-end data flows between UE 310 and the DN 150, between UE 310 and the service applications 140. The DN 150 and the service applications 140 may include but are not limited to data network and services provided by the operator of the wireless communication network 300 or by third-party data network and service providers.

The PCF 322 may be responsible for managing and providing various levels of policies and rules applicable to a communication session associated with the UE 310 to the AMF/SEAF 330 and SMF 340. As such, the AMF/SEAF 330, for example, may assign SMF 340 for the communication session according to policies and rules associated with the UE 310 and obtained from the PCF 322. Likewise, the SMF 340 may allocate UPF 350 to handle data routing and forwarding of the communication session according to policies and rules obtained from the PCF 322.

While FIGS. 1-3 and the various exemplary implementations described below are based on cellular wireless communication networks, the scope of this disclosure is not so limited and the underlying principles are applicable to other types of wireless and wireline communication networks.

Network identity and data security in the wireless communication network 300 of FIG. 3 may be managed via user authentication processes provided by the AMF/SEAF 330, the AUSF 360, and the UDM/ARPF 370. In particularly, the UE 310 may first communicate with AMF/SEAF 330 for network registration and may then be authenticated by the AUSF 360 according to user contract and subscription data in the UDM/ARPF 370. Communication sessions established for the UE 310 after user authentication to the wireless communication network 300 may then be protected by the various levels of encryption/decryption keys. The generation and management of the various keys may be orchestrated by the AUSF 360 and other network functions in the communication network 300.

### AKMA Framework

In the wireless communication network, the Application Function (AF, or application function entity) may provide application service to a UE. The AF may be deployed in various locations, such as a Home Public Land Mobile Network (HPLMN) of the UE, a Visited Public Land Mobile Network (VPLMN) of the UE (e.g., when the UE roams to the VPLMN), or a Data Network (DN) which is external to the HPLMN and the VPLMN. Secure or encrypted data communication between the AF and the UE may be implemented under an Authentication and Key Management for Applications (AKMA) framework. The AKMA framework may be based on various authentication procedures such as the 5G Authentication and Key Agreement (5G-AKA) method, the Extensible Authentication Protocol Method for 3rd Generation Authentication and Key Agreement (EAP-AKA′) method, the Extensible Authentication Protocol-Transport Layer Security (EAP-TLS) method, or the like.

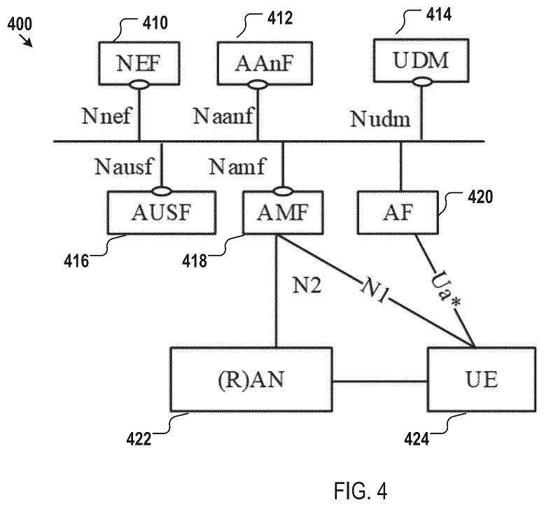

FIG. 4 illustrates an exemplary network model 400 for implementing an AKMA framework. This model includes various network elements. Each network element may be implemented as a physical entity, or a logical entity providing a particular set of network functions. A logical entity may be based on software, hardware, firmware, of any combination thereof. For example, a logical entity may include a server providing the function. For another example, a logical entity may be implemented based on cloud-based service or platform, such as Software as a service (SaaS), Platform as a service (PaaS), etc.

The AKMA Anchor Function (AAnF) 412 provides a security anchor function in the HPLMN. The AAnF stores the AKMA Anchor Key (K_{AKMA}) for AKMA service associated with UE 424, which is received from the Authentication Server Function (AUSF) 416 after the UE 424 completes a successful primary authentication. The AAnF may also generate the key material to be used between the UE and the Application Function (AF) 420 and maintains UE AKMA context (also referred to as AKMA security context).

The AF 420 may provide application service to the UE. Under the AKMA framework, the AF may request for its AKMA Application Key, denoted as K_{AF}, from the AAnF using an identifier for the K_{AKMA}. The identifier may include an AKMA Key Identifier (A-KID). The AAnF may only provide the KAF to the AF after the AF is authenticated and authorized by the operator network. The AF may be located inside or outside the operator's network. In this disclosure, for simplicity, the AKMA Application Key (K_{AF}) may also be referred to as the AF key.

The Network Exposure Function (NEF) 410 may be configured to enable and authorize external AFs to access the AKMA service and forward the AKMA service request towards the AAnF. The NEF may also perform the AAnF selection in case there are multiple AAnFs.

The AUSF 416 may provide the Subscription Permanent Identifier (SUPI) and AKMA key material (e.g., A-KID, K_{AKMA}) of the UE to the AAnF. The AUSF may also perform the AAnF selection.

The UDM may store AKMA subscription data of the subscriber (or the UE subscribed to the wireless communication network).

Referring to FIG. 4, various interfaces may be involved in the AKMA framework. These interfaces may include Nnef, Naanf, Nudm, Uausf, and Namf and may be referred to as Service Based Interface (SBI), as each interface corresponds to a service provided by a network element. For example, Nnef represnets the SBI utilized by the NEF; Naanf represents the SBI utilized by the AAnF; and Nudm represents the SBI utilized by the UDM. The network elements may interact with each other via the various SBIs. The SBI may provide security protection. For example, the SBI may be confidentiality, integrity and replay protected.

FIG. 4 shows the implementation where the AAnF is deployed as a standalone function. Other deployment options may be chosen. For example, the AAnF may be co-located with the AUSF, or the AAnF may be co-located with the NEF.

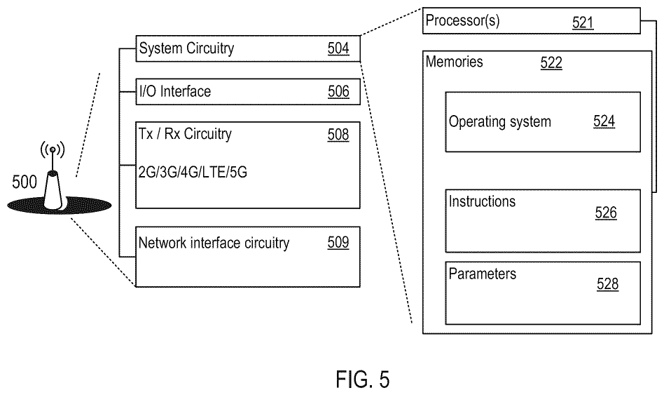

FIG. 5 shows an example of electronic device 500 to implement various network nodes, network elements, network entities, such as a network base station (e.g., a radio access network node), a core network (CN), a core network element/entity (e.g., an AMF, a UDM, an AAnF, etc.), an operation and maintenance (OAM), and the like. Optionally in one implementation, the example electronic device 500 may include radio transmitting/receiving (Tx/Rx) circuitry 508 to transmit/receive communication with UEs and/or other base stations. Optionally in one implementation, the electronic device 500 may also include network interface circuitry 509 to communicate the base station with other base stations and/or a core network, e.g., optical or wireline interconnects, Ethernet, and/or other data transmission mediums/protocols. The electronic device 500 may optionally include an input/output (I/O) interface 506 to communicate with an operator or the like.

The electronic device 500 may also include system circuitry 504. System circuitry 504 may include processor(s) 521 and/or memory 522. Memory 522 may include an operating system 524, instructions 526, and parameters 528. Instructions 526 may be configured for the one or more of the processors 521 to perform the functions of the network node. The parameters 528 may include parameters to support execution of the instructions 526. For example, parameters may include network protocol settings, bandwidth parameters, radio frequency mapping assignments, and/or other parameters.

In this disclosure, a network function/network entity/entity, such as an AMF, an AUSF, a UDM, an AAnF, an NEF, an AF, may be implemented in hardware, software, a combination of hardware and software, and may be implemented or integrated in the electronic device 500. They may also be implemented as a logical entity hosted by the electronic device 500.

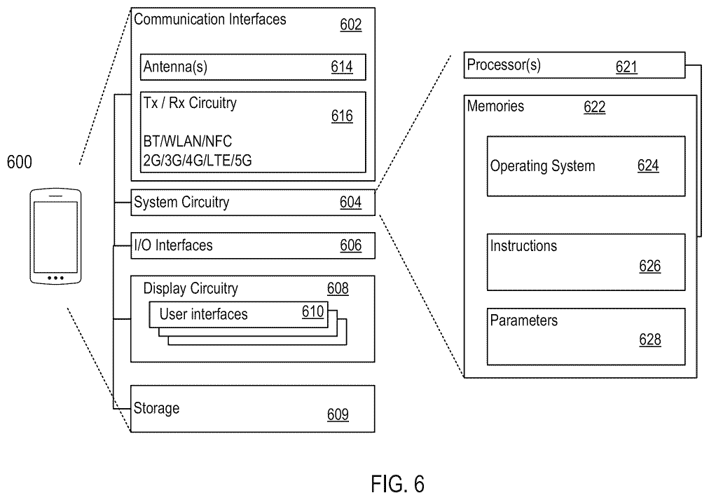

FIG. 6 shows an example of an electronic device to implement a terminal device 600 (for example, a UE). The UE 600 may be a mobile device, for example, a smart phone or a mobile communication module disposed in a vehicle. The UE 600 may include a portion or all of the following: communication interfaces 602, a system circuitry 604, an input/output interfaces (I/O) 606, a display circuitry 608, and a storage 609. The display circuitry may include a user interface 610. The system circuitry 604 may include any combination of hardware, software, firmware, or other logic/circuitry. The system circuitry 604 may be implemented, for example, with one or more systems on a chip (SoC), application specific integrated circuits (ASIC), discrete analog and digital circuits, and other circuitry. The system circuitry 604 may be a part of the implementation of any desired functionality in the UE 600. In that regard, the system circuitry 604 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 610. The user interface 610 and the inputs/output (I/O) interfaces 606 may include a graphical user interface, touch sensitive display, haptic feedback or other haptic output, voice or facial recognition inputs, buttons, switches, speakers and other user interface elements. Additional examples of the I/O interfaces 606 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 6, the communication interfaces 602 may include a Radio Frequency (RF) transmit (Tx) and receive (Rx) circuitry 616 which handles transmission and reception of signals through one or more antennas 614. The communication interface 602 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 602 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 6, the system circuitry 604 may include one or more processors 621 and memories 622. The memory 622 stores, for example, an operating system 624, instructions 626, and parameters 628. The processor 621 is configured to execute the instructions 626 to carry out desired functionality for the UE 600. The parameters 628 may provide and specify configuration and operating options for the instructions 626. The memory 622 may also store any BT, WiFi, 3G, 4G, 5G or other data that the UE 600 will send, or has received, through the communication interfaces 602. In various implementations, a system power for the UE 600 may be supplied by a power storage device, such as a battery or a transformer.

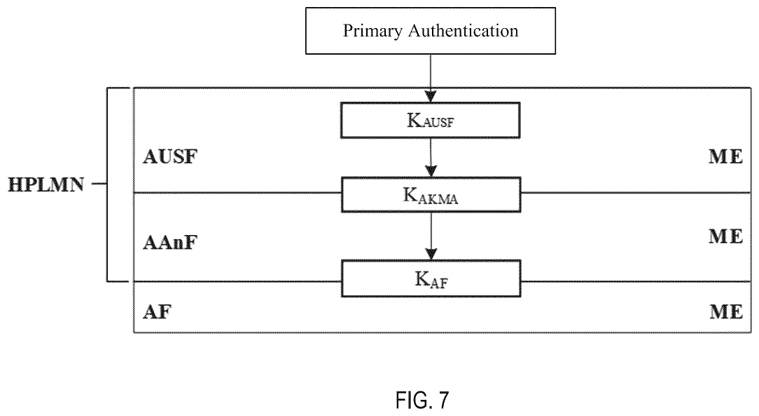

Under the AKMA framework, there may be various keys involved, and these keys may be organized in a hierarchical structure as shown in FIG. 7. The example key hierarchy of FIG. 7 may include the following keys at different level: K_{AUSF}, K_{AKMA}, and K_{AF}. These keys may be derived and stored in parallel on both the network side and the Mobile Equipment (ME) side. The ME refers to a portion of a UE along with other portions of UE such as a Universal Subscriber Identity Module (USIM).

After a successful primary authentication between the UE and the wireless communication network (e.g., UE authenticated by the operator), the AUSF and/or the UE may derive the K_{AUSF} based on an Integrity Key (IK) of the UE, and a Cipher Key (CK) of the UE. AUSF may alternatively derive the K_{AUSF} based on a transformation of the Integrity Key (denoted as IK′) of the UE, and a transformation of the Cipher Key (denoted as CK′) of the UE.

Based on the K_{AUSF}, the ME and the AUSF may each derive the K_{AKMA} based on the K_{AUSF}, and the SUPI of the UE, by using a Key Derivation Function (KDF).

Then based on the K_{AKMA}, the ME and the AAnF may each derive the K_{AF} based on the K_{AKMA}, and an identifier of the AF, also similarly by using a KDF. It is to be noted that a UE may store multiple K_{AF}, each corresponding to an AF. Likewise, an AF may store multiple K-AF, each corresponding to a UE.

The various keys described herein may each have a lifetime. For example, the K_{AKMA} may be refreshed until the next successful primary authentication. For another example, the KAF may be provisioned with a lifetime, for example, by the AAnF. In some embodiments, the lifetime of a key may be associated with a timer, such that the timer is started once a key is commissioned, and once the timer expires, the key is refreshed.

In a wireless communication network, a UE may subscribe to various application services from an AF. When invoking services provided by the AF, secure communication link needs to be established and maintained. An encryption key may be used to encrypt the data flow between the UE and the AF. Depending on use case scenarios, different key may be selected.

In one scenario, the UE is roaming in a VPLMN, and needs to invoke application service from an AF in its HPLMN. AKMA application key (KAF) may be used for encryption. Alternatively, an encryption key derived from K_{AF} may be used.

In another scenario, the UE is roaming in a VPLMN, and needs to invoke application service from an AF in a data network external to the HPLMN and VPLMN. In this case, K_{AF}, encryption key derived from K_{AF} may be used. The AF may also choose its own encryption key which is independent of K_{AF}.

The above scenarios impose special challenges to regulatory control in the HPLMN. For example, the encryption key may not be transparent, as the type of the encryption key need to be recognized. For another example, in case the encryption key independent of K_{AF} is used, the external AF may not even share the key with the VPLMN, yet this information needs to be passed to the regulatory control point. For another example, key storage mechanism needs to be implemented, so the encryption is made available to the VPLMN.

In this disclosure, various embodiments are disclosed for pushing encryption key to the VPLMN. These embodiments at least solve the challenges described above and improve wireless communication. Great detail including interactions between various network elements are described below.

### EMBODIMENT 1

### Key Transfer Using HPLMN AF for Roaming UE

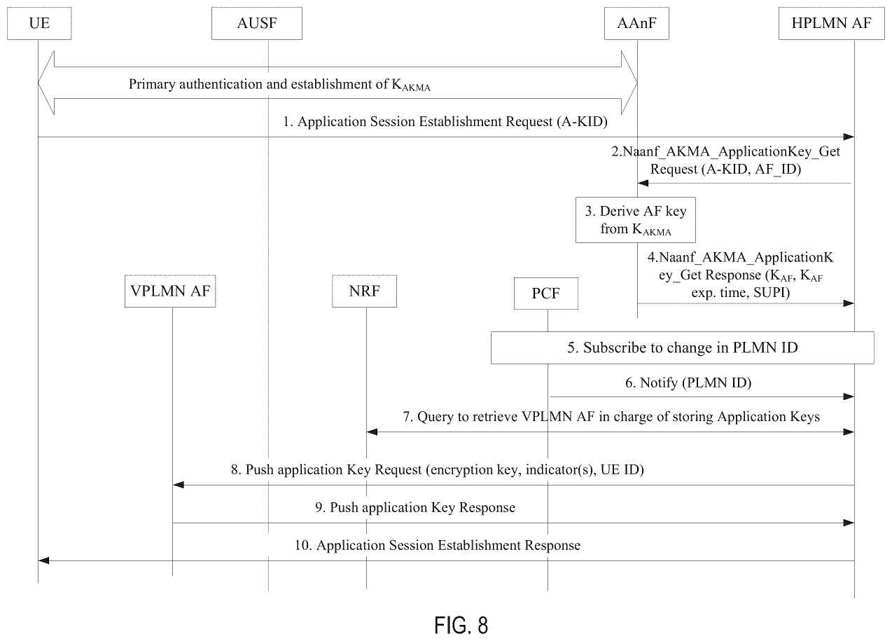

In this embodiment, the UE is roaming in a VPLMN and needs to request application service from an AF in its HPLMN. The HPLMN AF determines an NF in the VPLMN in charge of storing application keys by querying an NRF and pushes the application key to the VPLMN NF. The exemplary steps are described in details below with reference to FIG. 8.

step 0

This step serves as a prerequisite. The UE is roaming in a VPLMN, and successfully performs a primary authentication with the core network (e.g., AAnF, AUSF, etc.), for example, under the AKMA framework.

step 1

The UE may generate/derive the AKMA Anchor Key (K_{AKMA}) and the corresponding AKMA Key Identifier, A-KID, from the KAUSF before initiating communication with an AF. In this embodiment, UE invokes application service from an AF in the HPLMN (HPLMN AF) and may start with sending a message, such as an Application Session Establishment Request message, to the HPLMN AF. The Application Session Establishment Request message may include the derived A-KID. The UE may derive KAF before or after sending the Application Session Establishment Request message. The UE may further derive an encryption key based on the KAF. Both the KAF and the derived encryption key may be referred to as an application key, which may be used for encrypting a data flow between the HPLMN AF and the UE.

As described earlier, A-KID identifies the K_{AKMA} key of the UE. A-KID may be in a Network Access Identifier (NAI) format, i.e., username@realm. Specifically, the username part may include the Routing Identifier (RID) of the UE and the AKMA Temporary UE Identifier (A-TID), and the realm part may include Home Network Identifier.

A-TID may be derived from KAUSF and SUPI of the UE. For example, A-TID=KDF (“A-TID”, SUPI, K_{AUSF}), where KDF is the key derivation function.

step 2

If the HPLMN AF does not have an active context associated with the A-KID, then the HPLMN AF may select an AAnF base on its local policy or RID of the UE, and send a message, such as an Naanf_AKMA_ApplicationKey_Get request message, to the selected AAnF with the A-KID to request the KAF for the UE. The HPLMN AF may further include its identity (AF_ID) in the request message.

The AF_ID may include the Fully Qualified Domain Name (FQDN) of the AF and a security protocol identifier that the AF will use with the UE. As an example, the security protocol may include a Ua* security protocol.

In example implementations, the AAnF may check whether the AAnF can provide the service to the AF based on, for example, the configured local policy, or the authorization information available in the signaling (e.g., Oauth2.0 token). If the check fails, the AAnF may reject the request.

If the check succeeds, the AAnF may further verify whether the UE (subscriber) is authorized to use AKMA based on the presence of the UE specific K_{AKMA} key identified by the A-KID.

If K_{AKMA} is present in AAnF, the AAnF may continue with step 3.

If K_{AKMA} is not present in the AAnF, the AAnF may continue with step 4 with an error response.

step 3

The AAnF derives the AKMA Application Key (K_{AF}) from K_{AKMA} if it does not have K_{AF} readily available.

The derivation may be based on a KDF, for example, K_{AF}=KDF (AF_ID, KAKMA), where AF_ID=(FQDN of the AF∥Ua* security protocol identifier), “∥” is a concatenation operation.

step 4

The AAnF sends a response message, such as an Naanf_AKMA_ApplicationKey_Get response message to the HPLMN AF, and the response may include at least one of: SUPI, K_{AF}, and the K_{AF} expiration time.

If case K_{AKMA} is not present in the AAnF as described in step 2, the AAnF may reply back with an error response. The HPLMN AF, upon receiving the error indication, may proceed directly to step 10.

step 5

In a wireless network, depending on its location, the UE may be served by different PLMNs, such as its HPLMN, or VPLMNs if the UE is roaming. The HPLMN AF may need to determine which PLMN is serving the UE. In example implementations, the HPLMN AF may subscribe with the PCF to be notified of the PLMN ID of the PLMN to which the UE is currently registered (i.e., the PLMN serving the UE). The PCF may choose to send the PLMN ID to the HPLMN AF right after receiving the subscription.

In example implementations, the subscription may be triggered when the PLMN ID is updated. For example, due to UE roaming, the PCF will send updated PLMN ID to the HPLMN AF.

In example implementations, the PCF may additionally or alternatively send periodic notification on the PLMN ID.

step 6

As the UE is roaming in the VPLMN, the PCF forwards the PLMN ID of the VPLMN serving the UE to the HPLMN AF. The HPLMN AF stores the PLMN ID.

step 7

Before the HPLMN AF is able to push/transfer the application key to the VPLMN, it needs to first identify and locate the specific Network Function (NF) in the VPLMN which is in charge of storing application keys. The HPLMN AF may send a query message to the HPLMN Network Routing Function (NRF) to retrieve the specific VPLMN NF. In example implementations, the query message may carry the PLMN ID received in previous step and a query rule (e.g., for querying the NF that stores the application key). The query may be sent to the VPLMN NRF via the HPLMN NRF. The VPLMN NRF may return to the HPLMN AF a VPLMN NF (e.g. AMF, AAnF, SMF) that stores the application key in the form of an identifier or an address of the VPLMN NF. The VPLMN NF for storing application key may include an AMF, an AAnF, or an SMF.

step 8

After receiving the VPLMN NF that stores the application key, the HPLMN AF may send a push application key request message to the VPLMN NF. The message may carry the application key, which may include the K_{AF} or the encryption key derived from the K_{AF}. The application key may be used to encrypt the data flow between the UE and HPLMN AF. The message may further include an identifier of the UE, for example, the SUPI or the GPSI of the UE.

The message may further include a key indicator, which indicates whether the application key included in the message is the K_{AF} or the encryption key derived from the K_{AF}.

In some example implementations, the HPLMN AF may choose an encryption key from the application key mentioned earlier (K_{AF} or the encryption key derived from K_{AF}), or a different application key, to encrypt the data flow between the UE and the HPLMN AF. And the message may further include an indicator indicating one of: i) whether the carried key is the data flow encryption/decryption key between the UE and the HPLMN AF; or ii) it is undetermined whether the carried key is the data flow encryption/decryption key between the UE and the HPLMN AF.

step 9

The VPLMN NF receives the message sent in previous step and stores the application key carried in the message. The VPLMN NF may further establish a correspondence between the application key and the UE.

As a response, the VPLMN NF may send a Push application Key Response message to the HPLMN AF.

From this step, the VPLMN maintains a local copy of the application key.

step 10

The HPLMN AF sends an Application Session Establishment Response to the UE. If the information in step 4 indicates a failure of AKMA application key request, the AF may reject the Application Session Establishment by including a failure cause. Afterwards, UE may trigger a new Application Session Establishment request with the latest A-KID to the AKMA AF.

### EMBODIMENT 2

### Key Transfer Using HPLMN AF for Roaming UE

In this embodiment, the UE is roaming in a VPLMN and needs to request application service from an AF in its HPLMN. The HPLMN AF determines an NF in the VPLMN in charge of storing application keys via UDM and pushes the application key to the VPLMN NF. The exemplary steps are described in details below with reference to FIG. 8.

### Step 0

This step serves as a prerequisite and is optional. The UE is roaming in a VPLMN, and successfully performs a primary authentication with the core network (e.g., AAnF, AUSF, etc.), for example, under the AKMA framework.

### Step 1

The UE may generate/derive the AKMA Anchor Key (K_{AKMA}) and the corresponding AKMA Key Identifier, A-KID, from the KAUSF before initiating communication with an AF. In this embodiment, UE invokes application service from an HPLMN AF and may start with sending a message, such as an Application Session Establishment Request message, to the HPLMN AF. The Application Session Establishment Request message may include the derived A-KID in the Application Session Establishment Request message. The UE may derive KAF before or after sending the Application Session Establishment Request message. The UE may further derive an encryption key based on the K_{AF}. Both the K_{AF} and the derived encryption key may be referred to as an application key, which may be used for encrypting a data flow between the HPLMN AF and the UE.

As described earlier, A-KID identifies the K_{AKMA} key of the UE. A-KID may be in a Network Access Identifier (NAI) format, i.e., username@realm.

A-TID may be derived from KAUSF and SUPI of the UE. For example, A-TID=KDF (“A-TID”, SUPI, K_{AUSF}), where KDF is the key derivation function.

step 2

If the HPLMN AF does not have an active context associated with the A-KID, then the HPLMN AF may select an AAnF base on its local policy or RID of the UE, and send a message, such as an Naanf_AKMA_ApplicationKey_Get request message to the selected AAnF with the A-KID to request the K_{AF} for the UE. The HPLMN AF may further include its identity (AF_ID) in the request message.

The AF_ID may include the FQDN of the AF and a security protocol identifier that the AF will use with the UE. As an example, the security protocol may include a Ua* security protocol.

In example implementations, the AAnF may check whether the AAnF can provide the service to the AF based on, for example, the configured local policy, or the authorization information available in the signaling (e.g., Oauth2.0 token). If the check fails, the AAnF may reject the request.

If the check succeeds, the AAnF may further verify whether the UE (subscriber) is authorized to use A_{KMA} based on the presence of the UE specific K_{AKMA} key identified by the A-KID.

If K_{AKMA} is present in AAnF, the AAnF may continue with step 3.

If K_{AKMA} is not present in the AAnF, the AAnF may continue with step 4 with an error response.

step 3

The AAnF derives the AKMA Application Key (K_{AF}) from K_{AKMA} if it does not already have K_{AF} readily available.

The derivation may be based on a KDF, for example, K_{AF}=KDF (AF_ID, K_{AKMA}), where AF_ID=(FQDN of the AF∥Ua* security protocol identifier), “∥” is a concatenation operation.

step 4

The AAnF sends a response message, such as an Naanf_AKMA_ApplicationKey_Get response message to the HPLMN AF, and the response may include at least one of: SUPI, K_{AF}, and the K_{AF} expiration time.

If case K_{AKMA} is not present in the AAnF as described in step 2, the AAnF may reply back with an error response. The HPLMN AF, upon receiving the error indication, may proceed directly to step 10.

step 5

Before the HPLMN AF is able to push/transfer the application key to the VPLMN, it may need to first identify and locate a specific Network Function (NF) in the VPLMN which is in charge of storing application keys. The HPLMN AF may send a message, such as an Nudm_Get_Roaming_NFid Request message to the UDM with the UE ID, for querying the specific NF in the VPLMN. The UE ID may include at least one of: the SUPI of the UE, or the GPSI of the UE.

step 6

As a response, the UDM sends a response message, such as an

Nudm_Get_Roaming_NFid Response message to the HPLMN AF with VPLMN NF identification information identifying the specific NF in the VPLMN. The VPLMN NF identification information may include one of: i) AMF ID or AMF address of the AMF to which the UE is currently registered in the VPLMN network, or ii) the SMF ID or the SMF address of the SMF used in a local breakout mode. Note that in a local breakout mode, when establishing a PDU session for a UE, data traffic is routed directly from the VPLMN to the data network. The local breakout mode utilizes SMF and UPF in the VPLMN.

step 7

After receiving the VPLMN NF that stores the application key, the HPLMN AF may send a push application key request message to the VPLMN NF. The message may carry the application key, which may include the KAF or the encryption key derived from the KAF. The application key may be used to encrypt the data flow between the UE and HPLMN AF. The message may further include an identifier of the UE, for example, the SUPI or the GPSI of the UE.

The message may further include a key indicator, which indicates whether the application key included in the message is the K_{AF} or the encryption key derived from the K_{AF}.

In some example implementations, the HPLMN AF may choose an encryption key from the application key mentioned earlier (K_{AF}, or the encryption key derived from K_{AF}), or a different application key, to encrypt the data flow between the UE and the HPLMN AF. And the message may further include an indicator indicating one of: i) whether the carried key is the data flow encryption/decryption key between the UE and the HPLMN AF; or ii) it is undetermined whether the carried key is the data flow encryption/decryption key between the UE and the HPLMN AF.

step 8

The VPLMN NF receives the message sent in previous step and stores the application key carried in the message. The VPLMN NF may further establish a correspondence between the application key and the UE.

As a response, the VPLMN NF may send a Push application Key Response message to the HPLMN AF.

From this step, the VPLMN maintains a local copy of the application key.

step 9

The HPLMN AF sends an Application Session Establishment Response to the UE. If the information in step 4 indicates a failure of AKMA application key request, the AF may reject the Application Session Establishment by including a failure cause. Afterwards, UE may trigger a new Application Session Establishment request with the latest A-KID to the AKMA AF.

### EMBODIMENT 3

### Key Transfer Using AAnF for Roaming UE (AF in Data Network)

In this embodiment, the UE is roaming in a VPLMN and needs to request application service from an AF in a data network. The data network belongs to a third party, and is external to the HPLMN and the PLMN of the UE.

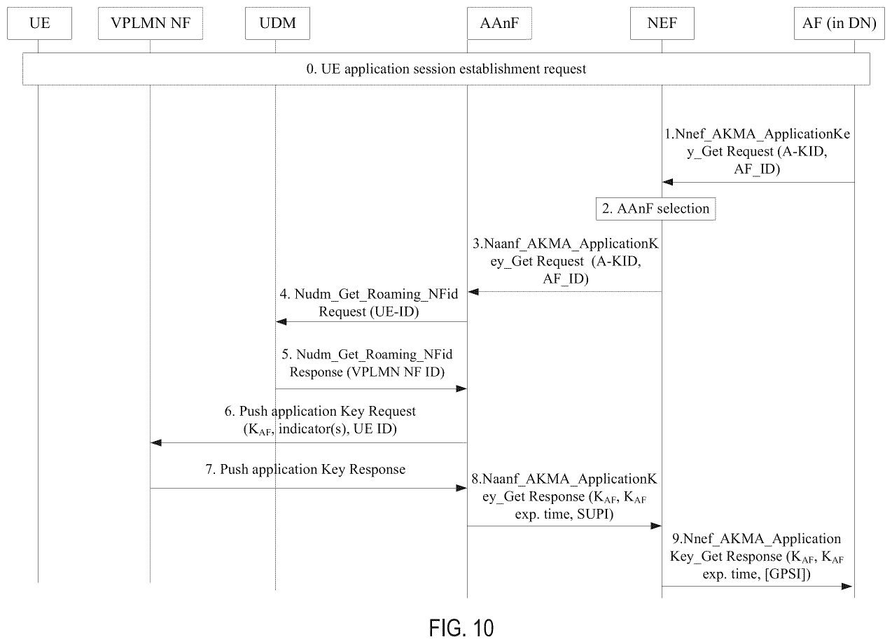

FIG. 10 shows exemplary steps for the AAnF to push the application key to an NF in the VPLMN in charge of storing application keys. The details are described below.

step 0

This step serves as a prerequisite. The UE initiates an application session establishment request for establishing an application service with the AF in the data network.

step 1

The AF needs to request AKMA Application Key (KAF) for the UE from an AAnF associated with the UE. In this case, the AF first discovers the HPLMN of the UE based on the A-KID associated with the UE, then sends a key request message, such as an Nnef_AKMA_ApplicationKey_Get Request message, towards the AAnF in the HPLMN. The key request message may include the A-KID, which may be sent to the AF in step 0, as well as an identifier of the AF (AF ID). Optionally, the key request message may further include an indicator indicating that a UE ID is not needed (this indicator may be referred to as a “UE ID not needed indicator”). In example implementations, the key request message may be sent via an NEF service Application Program Interface (API) such that the key request is delegated to the NEF.

step 2

If the AF is authorized by the NEF to request K_{AF}, the NEF discovers and selects an AAnF base on its local policy or RID of the UE.

step 3

The NEF sends or forwards the KAF request to the selected AAnF, to request the KAF for the UE. The request may include at least one of: the A-KID, or the AF identifier of the AF. The request may be sent via, for example, an Naanf_AKMA_ApplicationKey_Get Request message. The AAnF may process the request in following manner:
If K_{AKMA} is present in AAnF, the AAnF may continue with step 4.
If K_{AKMA} is not present in the AAnF, the AAnF may continue with step 8 with an error response.
   step 4

Upon receiving the K_{AF} request in step 3, the AAnF may process the request in following manner:

If K_{AKMA} is not present in the AAnF, then the AAnF may proceed to step 8 by sending a response to the NEF indicate an error.

If K_{AKMA} is present in AAnF, the AAnF generates the K_{AF}. In this embodiment, the AAnF is responsible to push the application key to a specific VPLMN NF in charge of storing application keys. The AAnF may query the UDM to retrieve the specific VPLMN NF. For example, as shown in FIG. 10, the AAnF may send an Nudm_Get_Roaming_NFid Request message to the UDM with the UE ID. The UE ID may be, for example, the SUPI of the user.

step 5

As a response, the UDM sends a response message, for example, an Nudm_Get_Roaming_NFid Response message to the AAnF with the VPLMN NF identification information identifying the specific VPLMN NF in charge of storing application keys. The VPLMN NF identification information may include one of: i) AMF ID or AMF address of the AMF to which the UE is currently registered in the VPLMN network, or ii) the SMF ID or the SMF address of the SMF used in a local breakout mode.

step 6

After receiving identification information of the VPLMN NF that stores application keys, the AAnF may push the application key to the VPLMN NF via, for example, a push application key request message. The message may carry the K_{AF}. The message may further include an identifier of the UE, for example, the SUPI of the UE.

As the AF in a third party data network, depending on the agreement between the third party and the HPLMN/VPLMN, the AF may or may not use the K_{AF} to encrypt the data flow between the UE and the AF. In some example implementations, the AAnF is able to determine that K_{AF} is used to encrypt the data flow. However, in some other implementations, the AAnF may not be able to determine whether K_{AF} is used to encrypt the data flow. Therefore, the push application key request message may further include an indicator indicating one of following scenarios: i) the carried key is the encryption/decryption key of the data flow between the UE and the AF; or ii) it is un-determined whether the carried key is the encryption/decryption key of the data flow between the UE and the AF. Note that the second scenario may be understood as a best-effort implementation, as it will be up to the VPLMN for making a choice whether to try the application key sent in the push application key request message. In example implementations, this indicator may further indicate that the carried key is K_{AF}.

step 7

The VPLMN NF receives the message sent in previous step and stores the application key carried in the message. The VPLMN NF may further establish a correspondence between the application key and the UE.

As a response, the VPLMN NF may send a Push application Key Response message to the AAnF.

step 8

The AAnF sends a response to the NEF with the K_{AF}, the K_{AF} expiration time (KAF exp. time) and SUPI of the UE. The response may be sent via, for example, an Naanf_AKMA_ApplicationKey_Get Response message.

Note that if K_{AKMA} is not present in the AAnF, the AAnF may send a response to the NEF indicating the error condition.

step 9

The NEF forwards the response to the AF with the K_{AF}, the K_{AF} expiration time and optionally the GPSI of the UE (external ID of the UE) via, for example, an Naanf_AKMA_ApplicationKey_Get Response message. Based on local policy, the NEF may use the Nudm_SubscriberDataManagement service to translate SUPI to GPSI and optionally include the GPSI (external ID) in the response. If UE ID not needed indicator is included in the key request message in step 1, the NEF will not provide the GPSI to the AF. Also note that the NEF will not send the SUPI of the UE to the AF.

Note that if step 8 indicates an error condition, the NEF will forward the error condition to the AF.

### EMBODIMENT 4

### Key Transfer Using NEF for Roaming UE (AF in Data Network)

In this embodiment, the UE is roaming in a VPLMN and needs to request application service from an AF in a data network. The data network belongs to a third party, and is external to the HPLMN and the PLMN of the UE. An NEF is used for transferring application key to the specific VPLMN NF in charge of storing keys.

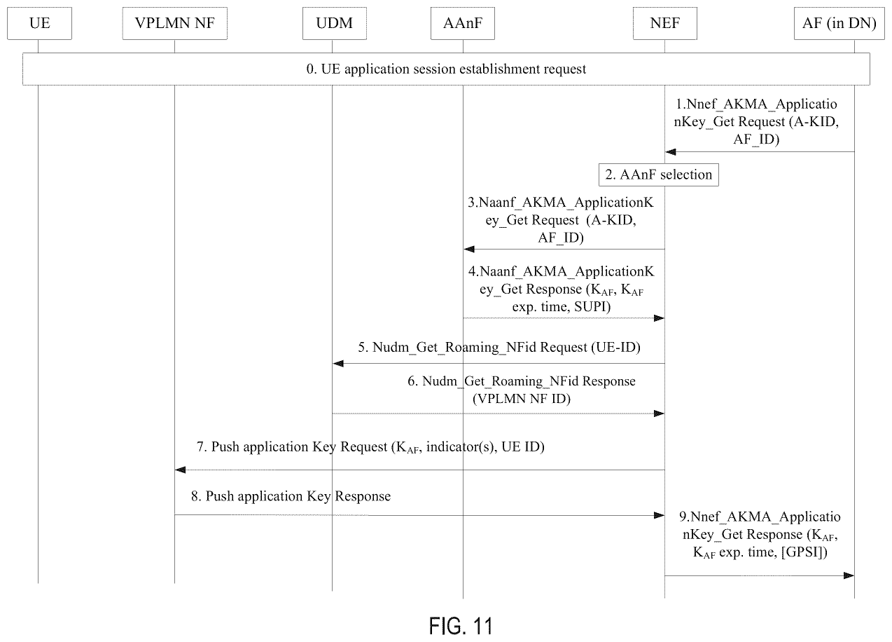

FIG. 11 shows exemplary steps for the NEF to push the application key to the VPLMN NF. The details are described below.

step 0

This step serves as a prerequisite. The UE initiates an application session establishment request for establishing application service with the AF in the data network.

step 1

The AF needs to request AKMA Application Key (K_{AF}) for the UE from an AAnF associated with the UE. In this case, the AF first discovers the HPLMN of the UE based on the A-KID associated with the UE, then sends a key request message, such as an Nnef_AKMA_Naanf_AKMA_ApplicationKey_Get Request message, towards the AAnF in the HPLMN. The key request message may include the A-KID, which may be sent to the AF in step 0, as well as an identifier of the AF (AF ID). Optionally, the key request message may further include an indicator indicating that a UE ID is not needed in the response (this indicator may be referred to as a “UE ID not needed indicator”). In example implementations, the key request message may be sent via an NEF service API such that the key request is delegated to the NEF.

step 2

If the AF is authorized by the NEF to request KAF, the NEF discovers and selects an AAnF base on its local policy or RID of the UE.

step 3

The NEF sends or forwards the KAF request to the selected AAnF, to request the K_{AF} for the UE. The request may include at least one of: the A-KID, or the AF identifier of the AF. The request may be sent via, for example, an Naanf_AKMA_ApplicationKey_Get Request message.

step 4

Upon receiving the K_{AF} request in step 3, the AAnF may process the request in following manner:
If K_{AKMA} is present in AAnF, the AAnF generates the K_{AF} and sends a response to the NEF with the K_{AF}, the K_{AF} expiration time (K_{AF} exp. time) and SUPI of the UE. The response may be sent via, for example, an Naanf_AKMA_ApplicationKey_Get Response message.

If K_{AKMA} is not present in the AAnF, not shown in FIG. 11, the AAnF may send a response to the NEF with an error indication. The NEF will proceed with step 9 by sending an error indication to the AF.

step 5

In this embodiment, the NEF is responsible to push the application key to a specific VPLMN NF in charge of storing application keys. Assuming response message in step 4 indicates a success, the NEF may query the UDM to retrieve the specific VPLMN NF. For example, the NEF may send an Nudm_Get_Roaming_NFid Request message to the UDM with the UE ID. The UE ID may be, for example, the SUPI, or the GPSI of the user.

step 6

As a response, the UDM sends a response message, for example, an Nudm_Get_Roaming_NFid Response message to the NEF with the VPLMN NF identification information identifying the specific VPLMN NF in charge of storing application keys. The VPLMN NF identification information may include one of: i) AMF ID or AMF address of the AMF to which the UE is currently registered in the VPLMN network, or ii) the SMF ID or the SMF address of the SMF used in a local breakout mode.

step 7

After receiving identification information of the VPLMN NF that stores application keys, the NEF may push the application key to the VPLMN NF via, for example, a push application key request message. The message may carry the K_{AF}. The message may further include an identifier of the UE, for example, the SUPI of the UE.

As the AF in a third party data network, depending on the agreement between the third party and the HPLMN/VPLMN, the AF may or may not use the K_{AF} to encrypt the data flow between the UE and the AF. In some example implementations, the NEF is able to determine that K_{AF} is used to encrypt the data flow. However, in some other implementations, the NEF may not be able to determine whether K_{AF} is used to encrypt the data flow. Therefore, the push application key request message may further include an indicator indicating one of following scenarios: i) the carried key is the encryption/decryption key of the data flow between the UE and the AF; or ii) it is un-determined whether the carried key is the encryption/decryption key of the data flow between the UE and the AF. Note that the second scenario may be understood as a best-effort implementation, as it will be up to the VPLMN for making a choice whether to try the application key sent in the push application key request message. In example implementations, this indicator may further indicate that the carried key is K_{AF}.

step 8

The VPLMN NF receives the message sent in previous step and stores the application key carried in the message. The VPLMN NF may further establish a correspondence between the application key and the UE.

As a response, the VPLMN NF may send a Push application Key Response message to the NEF.

step 9

The NEF forwards the response to the AF with the KAF, the KAF expiration time and optionally the GPSI of the UE (external ID of the UE). The response may be sent via, for example, an Nnef_AKMA_ApplicationKey_Get Response message. Based on local policy, the NEF may use the Nudm_SubscriberDataManagement service to translate SUPI to GPSI and optionally include the GPSI (external ID for the UE) in the response. If UE ID not needed indicator is included in the key request message in step 1, the NEF will not provide the GPSI to the AF. Also note that the NEF will not send the SUPI of the UE to the AF.

Note that if the response message in step 4 indicates an error, the NEF may send a response to the AF indicating the error.

### High Level System View

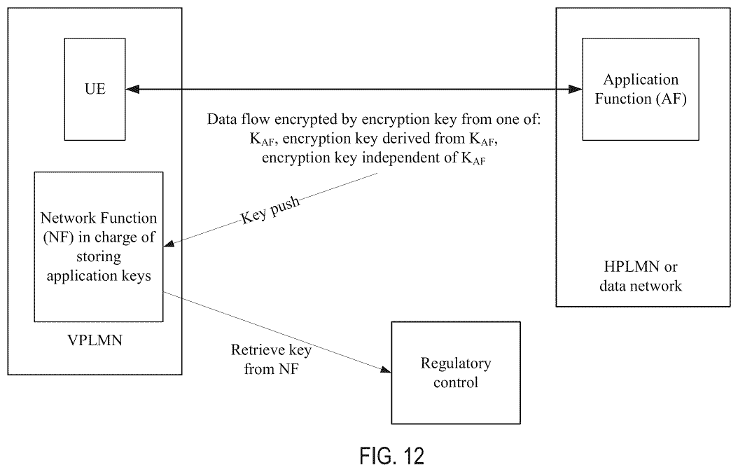

FIG. 12 shows an exemplary high level system view for transferring encryption key to a VPLMN in which the UE is roaming.

As shown in FIG. 12, the UE is roaming in the VPLMN, and invokes an application service with an AF in the HPLMN or an external data network. The data flow between the UE and the AF is encrypted by one of following keys: i) the KAF; ii) an encryption key derived from the K_{AF}; iii) an encryption key independent of K_{AF}.

The encryption key may be pushed to an NF in the VPLMN for storage and future retrieval. Various network functions/network entities, including HPLMN AF, AAnF, or NEF, may be used for pushing the key.

Additionally, when pushing the encryption key to the VPLMN NF, various indicators may be sent. For example, there may be an indicator indicating what key is pushed, whether the key is a K_{AF}, an encryption key derived from K_{AF}, or an encryption key independent of K_{AF}. There may also be an indicator indicating whether the pushed key is used for encrypting the data flow between the UE and the AF, or it is undetermined that the pushed key is used for the encryption.

In example implementations, instead of using multiple indicators as described above, a single indicator may be used to make these indications.

In example implementations, when the AF is inside the HPLMN, the encryption key pushed to the VPLMN NF may include one of: a K_{AF}, an encryption key derived from K_{AF}, or an encryption key independent of K_{AF}. And the encryption key is used for encrypting a data flow between the UE and the AF.

In example implementations, when the AF is in an external data network, the encryption key pushed to the VPLMN NF may be the K_{AF}, even though real encryption key used for encrypting a data flow between the UE and the AF is independent of K_{AF}, and may be unknown to the HPLMN/VPLMN.

In example implementations, when the AF is in an external data network, if the agreement between the external AF and the HPLMN (or VPLMN) allows encryption key sharing, the real encryption key used for encrypting a data flow between the UE and the external AF may be pushed to the VPLMN NF.

Once there is a local storage of the encryption key, regulatory control may be supported. For example, the stored encryption key may be sent to a regulatory control point when needed.

In this disclosure, K_{AF} is used for exemplary purpose only. The same concept for push encryption key may apply to other types of keys, such as K_{AKMA}.

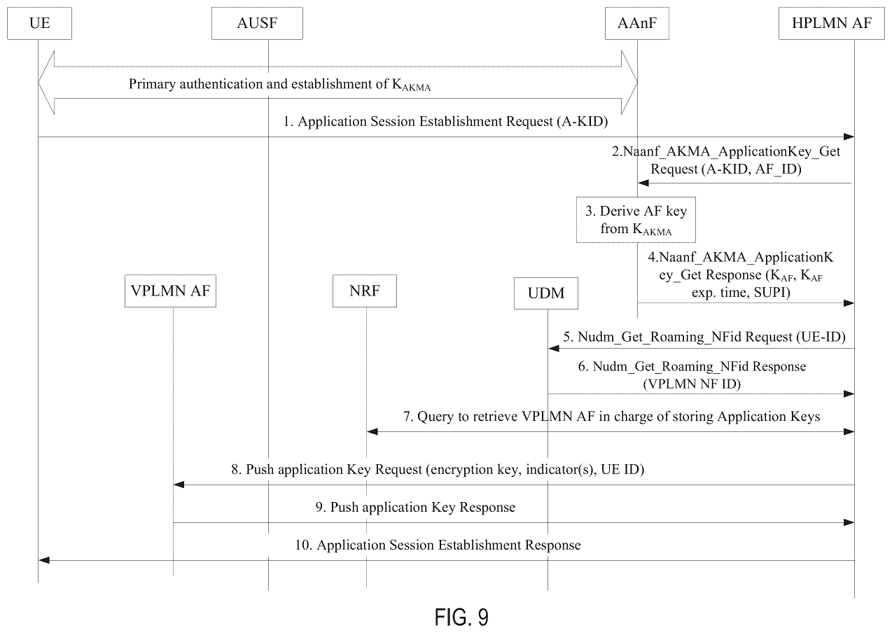

In this disclosure, message types and/or message names (e.g., as shown in FIGS. 8-11) are for exemplary purpose only. Different message types and/or message names may be chosen in implementation, and should still be covered by this disclosure, as far as the underlying principle is the same, for example, if the messages are used for a same purpose.

In this disclosure, a single message may be split into multiple sub-messages. Multiple messages may also be combined and sent in one message.

In this disclosure, a single information element in a message may be split into multiple information elements. Multiple information element may also be combined into a single information element.

The present disclosure describes methods, apparatus, and computer-readable medium for wireless communication. The present disclosure addressed the issues with pushing encryption key to a VPLMN. The methods, devices, and computer-readable medium described in the present disclosure may facilitate regulatory control requirement. The methods, devices, and computer-readable medium described in the present disclosure may improve the overall performance of the wireless communication systems.

In this disclosure, various embodiments are disclosed for updating/refreshing security configuration in various network entities such as AF, and UE. An AF may detect a security configuration to be expired, lost, or out of sync with the other network elements. Various mechanisms are described for the AF to refresh its security configuration and synchronize the security configuration update to the UE. In exemplary embodiments, the AAnF may further check if a valid UE security context is locally configured in the AAnF, via various approaches. Based on the check result, the AAnF may bypass procedures for soliciting UE security context from the core network thus saving signaling overhead and improving efficiency.

In this disclosure, the steps in each embodiment are for illustration purposes only and other alternatives may be derived based on the disclosed embodiments as desired. For example, only part of the steps may need to be performed. For another example, the sequence of the steps may be adjusted. For another example, several steps may be combined (e.g., several messages may be combined in one message). For yet another example, a single step may be split (e.g., one message may be sent via two sub-messages).

The accompanying drawings and description above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, performed by a first network element in a Home Public Land Mobile Network (HPLMN) of a wireless device, the wireless device being served by a Visited Public Land Mobile Network (VPLMN), and the method comprising:
transmitting a query message to a second network element, to request an identification of a Network Function (NF) entity, wherein the query message comprises an identifier of the wireless device, and wherein the network function is an entity in the VPLMN for storing encryption keys;
receiving, from the second network element, a response to the query message, the response comprising the identification of the NF entity; and
transmitting, to the NF entity based on the identification of the NF entity, a first message comprising:
a target encryption key comprising one of: an application key associated with the wireless device and an application function (AF) entity that the wireless device accesses for an application service, an encryption key derived from the application key, or an encryption key independent of the application key, wherein the AF entity is located in the HPLMN or a data network (DN) external to the HPLMN and the VPLMN, and wherein the target encryption key is used for encrypting a data flow between the wireless device and the AF entity.

2. The method of claim 1, wherein the first message further comprises the identifier of the wireless device.

3. The method of claim 1, wherein the application key comprises an Authentication and Key Management for Applications (AKMA) application key.

4. The method of claim 1, wherein the wireless device comprises a User Equipment (UE), and wherein the identifier of the wireless device comprises at least one of:
a Subscription Permanent Identifier (SUPI) of the UE; or
a Generic Public Subscription Identifier (GPSI) of the UE.

5. (canceled)

6. The method of claim 1, wherein:
the AF entity is located in the DN external to the HPLMN and the VPLMN; and
it is undetermined whether the target encryption key is used for encrypting a data flow between the wireless device and the AF entity.

7. The method of claim 1, wherein:
the first message further comprises at least one of: a first indicator; or a second indicator;
the first indicator indicates whether the target encryption key is the application key, the encryption key derived from the application key, or the encryption key independent of the application key;
the second indicator indicates one of:
that the target encryption key is used for encrypting a data flow between the wireless device and the AF entity; or
that it is undetermined whether the target encryption key is used for encrypting the data flow between the wireless device and the AF entity.

8. The method of claim 1, wherein:
the first message further comprises a first indicator; and
the first indicator indicates whether the target encryption key is the application key, the encryption key derived from the application key, or the encryption key independent of the application key.

9. The method of claim 8, wherein the first indicator further indicates one of:
that the target encryption key is used for encrypting a data flow between the wireless device and the AF entity; or that it is undetermined whether the target encryption key is used for encrypting the data flow between the wireless device and the AF entity.

10. The method of claim 1, wherein the query message comprises an Nudm_Get_Roaming_NFid request message, and wherein the response to the query message comprises an Nudm Get Roaming NFid response message.

11. (canceled)

12. The method of claim 1, wherein:
the first message comprises a push application key request message; and
the method further comprises:
receiving, from the NF entity, a push application key response message as a response to the first message.

13. The method of claim 1, wherein:
the NF entity comprises at least one of:
an Access and Mobility Management Function (AMF) to which the wireless device is registered, the AMF being located in the VPLMN;
a Session Management Function (SMF) associated with a Protocol Data Unit (PDU) session of the wireless device established in the VPLMN under a local breakout mode, the SMF being located in the VPLMN; or
an AKMA Anchor Function (AAnF) in the VPLMN; and
the identification of the NF entity comprises at least one of:
an identifier of the AMF;
an address of the AMF;
an identifier of the SMF; or
an address of the SMF.

14. The method of claim 13, wherein:
the first network element is the AF entity;
the second network element comprises a Network Repository Function (NRF) in the VPLMN; and
before transmitting the query message, the method further comprises:
subscribing with a Policy Control Function (PCF) to receive a Public Land Mobile Network (PLMN) identifier of a PLMN to which the wireless device is currently registered; and
receiving, from the PCF, a PLMN identifier of the VPLMN that currently serves the wireless device.

15. The method of claim 14, wherein transmitting the query message comprises:
transmitting the query message to the NRF in the VPLMN via an NRF in the HPLMN according to the PLMN identifier of the VPLMN, to request the identification of the NF entity.

16. (canceled)

17. The method of claim 1, wherein:
the first network element is the AF entity located in the HPLMN; and
the second network element comprises a Unified Data Management (UDM).

18. The method of claim 1, wherein:
the first network element comprises an AAnF;
the second network element comprises a UDM;
the AF entity is located in the DN external to the HPLMN and the VPLMN;
the application key is an AKMA application key associated with the wireless device; and
before transmitting the query message to the second network element, the method further comprises:
receiving, from a Network Exposure Function (NEF), a first application key request message for requesting the application key, wherein a transmission of the first application key request message by the NEF is triggered by a reception of a second application key request message from the AF entity for requesting the application key.

19-22. (canceled)

23. The method of claim 1, wherein:
the first network element comprises an NEF;
the second network element comprises a UDM;
the AF entity is located in the DN external to the HPLMN and the VPLMN;
the application key is an AKMA application key associated with the wireless device; and
before transmitting the query message to the second network element, the method further comprises:
receiving, from the AF entity, a first application key request message for requesting the application key.

24. The method of claim 23, further comprising:
transmitting, to an AAnF in the VPLMN, a second application key request message for requesting the application key, the second application key request message comprising at least one of:
an AKMA key identifier associated with the wireless device; or
an identifier of the AF entity; and
receiving, from the AAnF, a response message to the second application key request message, the response message comprising at least one of:
the application key;
an indication of an expiration time of the application key; or
an identifier of the wireless device.

25-27. (canceled)

28. A first network element comprising a memory for storing computer instructions and a processor in communication with the memory, wherein the first network element is in a Home Public Land Mobile Network (HPLMN) of a wireless device, the wireless device being served by a Visited Public Land Mobile Network (VPLMN), wherein, when the processor executes the computer instructions, the processor is configured to cause the first network element to:
transmit a query message to a second network element, to request an identification of a Network Function (NF) entity, wherein the query message comprises an identifier of the wireless device, and wherein the network function is an entity in the VPLMN for storing encryption keys;
receive, from the second network element, a response to the query message, the response comprising the identification of the NF entity; and
transmit, to the NF entity based on the identification of the NF entity, a first message comprising:
a target encryption key comprising one of: an application key associated with the wireless device and an application function (AF) entity that the wireless device accesses for an application service, an encryption key derived from the application key, or an encryption key independent of the application key, wherein the AF entity is located in the HPLMN or a data network (DN) external to the HPLMN and the VPLMN, and wherein the target encryption key is used for encrypting a data flow between the wireless device and the AF entity.

29. The first network element of claim 28, wherein:
the first message further comprises the identifier of the wireless device;
the application key comprises an Authentication and Key Management for Applications (AKMA) application key; and
the wireless device comprises a User Equipment (UE), and wherein the identifier of the wireless device comprises at least one of:
a Subscription Permanent Identifier (SUPI) of the UE; or
a Generic Public Subscription Identifier (GPSI) of the UE.

30. A non-transitory storage medium for storing computer readable instructions, the computer readable instructions, when executed by a processor in a first network element in a Home Public Land Mobile Network (HPLMN) of a wireless device, causing the processor to:
transmit a query message to a second network element, to request an identification of a Network Function (NF) entity, wherein the query message comprises an identifier of the wireless device, the wireless device being served by a Visited Public Land Mobile Network (VPLMN), and wherein the network function is an entity in the VPLMN for storing encryption keys;
receive, from the second network element, a response to the query message, the response comprising the identification of the NF entity; and
transmit, to the NF entity based on the identification of the NF entity, a first message comprising:
a target encryption key comprising one of: an application key associated with the wireless device and an application function (AF) entity that the wireless device accesses for an application service, an encryption key derived from the application key, or an encryption key independent of the application key, wherein the AF entity is located in the HPLMN or a data network (DN) external to the HPLMN and the VPLMN, and wherein the target encryption key is used for encrypting a data flow between the wireless device and the AF entity.
